(19) United States
(12) Patent Application Publication
(10) Pub. No.: US 2025/0307386 A1
(43) Pub. Date: Oct. 2, 2025

(54) CONTEXTUAL ATTACK DISRUPTION ENGINE IN A SECURITY MANAGEMENT SYSTEM

(71) Applicant: Microsoft Technology Licensing, LLC, Redmond, WA (US)

(72) Inventors: Daniel DAVRAYEV, Or Yehuda (IL); Andrey Karpovsky, Kiryat Motzkin (IL); Ofir Monza, Mishmar David (IL); Tamer Salman, Haifa (IL); Josef Weizman, Haifa (IL)

(21) Appl. No.: 18/620,756

(22) Filed: Mar. 28, 2024

(51) Int. Cl. G06F 21/55

(52) U.S. Cl. CPC G06F 21/554; G06F 2221/034

(57) ABSTRACT

Methods, systems, and computer storage media for providing context-based attack disruption using a contextual attack disruption engine of a security management system are described. Context-based attack disruption refers to attack disruption planning that allows for a comprehensive consideration of both contextual factors influencing a security incident and the broader impact to a computing environment for a security management system. The contextual attack disruption engine supports prioritizing and addressing security incidents based on context and impact of security incidents in computing environments. In operation, a security incident associated with a computing environment is identified. A security incident predictive model analysis associated with a plurality of attacks paths is generated. An attack path context for a predicted attack path is generated. A security incident impact analysis for the predicted attack path is generated. An attack disruption plan is generated. The attack disruption plan is communicated to be executed on the computing environment.

### BACKGROUND

Users rely on computing environments with applications and services to accomplish computing tasks. Distributed computing systems host and support different types of applications and services in managed computing environments. In particular, computing environments can implement a security management system that provides security posture management functionality and supports threat protection in the computing environments. For example, cloud security posture management (CSPM) and enterprise security posture management can include the following: identifying and remediating risk by automating visibility, executing uninterrupted monitoring and threat detection, and providing remediation workflows to search for misconfigurations across diverse cloud computing environments and infrastructure.

### SUMMARY

Various aspects of the technology described herein are generally directed to systems, methods, and computer storage media for, among other things, providing context-based attack disruption using a contextual attack disruption engine of a security management system. Security management generally refers to planning, implementing, controlling, and monitoring security measures to protect assets, resources, and information from various threats and risks in computing environment. Context-based attack disruption refers to attack disruption planning that allows for a comprehensive consideration of both contextual factors influencing a security incident and the broader impact to a computing environment.

The contextual attack disruption engine operates to generate one or more attack disruption plans (e.g., candidate attack disruption paths) and to select a designated attack disruption plan (e.g., an optimal attack disruption plan). An attack disruption plan is a context-impact-based incident response configuration for responding to an identified security incident. In particular, the contextual attack disruption engine generates a security incident predictive model analysis that includes one or more predicted attack paths; generates attack path contexts for each of the plurality of predicted attack paths; generates a security incident impact analysis for each of the plurality of predicted attack paths; generates one or more candidate attack disruption paths; and selects a designated attack disruption plan from the one or more candidate attack disruption plans.

Conventionally, security management systems are not configured with a comprehensive computing logic and infrastructure to efficiently and adequately provide context-based attack disruption. For example, security responses to security incidents do not take into consideration the context of the potential impact of the security incident. Moreover, the security incident can be a multi-stage security incident that is live security incident that is currently ongoing or actively unfolding. During a live security incident, the computing environment is under attack or have been compromised, and active response to the security is being performed to contain, investigate, and mitigate the threat.

A technical solution—to the limitations of conventional security management systems—can include providing contextual attack disruption resources via a contextual attack disruption engine that supports context-based attack disruption in a security management system. Contextual attack disruption resources can include operations for generating security incident predictive model analysis and security incident impact analysis that are employed in a security incident predictive model to generate and select a designated attack disruption plan. Moreover, the contextual attack disruption engine can generate contextual attack disruption data that can be received and provided via an interface to support analysis of a security incident. The contextual attack disruption data can include security incident predictive model analysis having predicated attack paths of a security incident, security incident impact analysis, and additional insights. As such, the security management system can be improved based on contextual attack disruption resources that operate to provide efficient context-based attack disruption attack disruption planning.

In operation, a security incident associated with a computing environment is identified. A security incident predictive model analysis is generated. The security incident predictive model analysis identifies a predicted attack path for the security incident, the predicated attack path is associated with a plurality of predicted attack paths for the security incident. An attack path context is generated for the predicted attack path. Using the attack path context, a security incident impact analysis is generated for the predicted attack path. The security incident impact analysis is a predicted quantified security incident cost of the security incident on the attack path in the computing environment. An attack disruption plan is generated, the attack disruption plan is associated with a plurality of candidate attack disruption plans that correspond to the plurality of attack paths. The attack disruption plan is selected as a designated attack disruption plan. The designated attack disruption plan is associated with a loss minimization score. The designated attack disruption plan is communicated to be executed on the computing environment.

In a second embodiment, a request for a security posture for a computing environment is communicated. Based on communicating the request, a security posture visualization comprising contextual attack disruption data associated with a security incident and a plurality of predicted attack paths is received. The security posture visualization is caused to be displayed.

In a third embodiment, a security incident is identified. A security incident predictive model analysis associated with a plurality of attacks paths is generated. Attack path contexts for each of the plurality of predicted attack paths are generated. A security incident impact analysis for each of the plurality of predicted attack paths is generated. Contextual attack disruption data is generated. The contextual attack disruption data is communicated.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIG. 1 is a block diagram of an exemplary security management system including a contextual attack disruption engine, in accordance with aspects of the technology described herein;

FIGS. 2A and 2B are flow diagrams associated with an exemplary security management system including a contextual attack disruption engine, in accordance with aspects of the technology described herein;

FIG. 3 provides a first exemplary method of providing contextual attack disruption using a contextual attack disruption engine, in accordance with aspects of the technology described herein;

FIG. 4 provides a second exemplary method of providing contextual attack disruption using a contextual attack disruption engine, in accordance with aspects of the technology described herein;

FIG. 5 provides a third exemplary method of providing contextual attack disruption using a contextual attack disruption engine, in accordance with aspects of the technology described herein;

FIG. 6 provides a block diagram of an exemplary security management system suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### Overview

A security management system supports management of security aspects of resources and workloads in computing environments. The security management system can help enable protection against threats, help reduce risk across different types of computing environments, and help strengthen a security posture of computing environments—i.e., security status and remediation action recommendations for computing resources including networks and devices. For example, the security management system can provide real-time security alerts, centralize insights for different resources, and provide for preventative protection, post-breach detection, and automated investigation, and response.

Conventionally, security management systems are not configured with a comprehensive computing logic and infrastructure to efficiently and adequately provide context-based attack disruption. For example, security responses to security incidents do not take into consideration the context of the potential impact of the security incident. Moreover, the security incident can be a multi-stage security incident that is live security incident that is currently ongoing or actively unfolding. During a live security incident, the computing environment is under attack or have been compromised, and active response to the security is being performed to contain, investigate, and mitigate the threat.

Merely employing the same techniques to every security incident—and especially live security incidents without additional context-based attack disruption causes deficient function of the security management system. For example, a deficient security posture interface does not adequately present the security posture information in a manner that efficiently summarizes the security posture of a computing environment. Moreover, without adequate security exposure analysis and prioritization of security issues—such as security issue tasks—in security posture information, high impact threats are not expediently addressed and potential threats can become actual threats which can lead to unauthorized access to data in the computing environment and malicious operations in the computing environment. As such, a more comprehensive security management system—with an alternative basis for performing secure management operations—can improve computing operations and interfaces in security management systems.

Embodiments of the present technical solution are directed to systems, methods, and computer storage media for, among other things, providing context-based attack disruption using a contextual attack disruption engine of a security management system. Security management generally refers to planning, implementing, controlling, and monitoring security measures to protect assets, resources, and information from various threats and risks in computing environment. Context-based attack disruption refers to attack disruption planning that allows for a comprehensive consideration of both contextual factors influencing a security incident and the broader impact to a computing environment. The security management system supports a contextual attack disruption framework of computing components associated with generating security incident predictive model analysis, attack path contexts, security incident impact analysis, and contextual attack disruption plans and data. Contextual attack disruption data associated with contextual attack disruption functionality is accessible via a security management client.

The contextual attack disruption engine supports prioritizing and addressing security incidents based on context and impact of security incidents on a computing environment. For example, a first security incident that involves a storage account that stores sensitive information can be prioritized for investigation over a second security incident that involves a storage account that stores non-sensitive information. Context refers to relevant information (e.g., contextual objects) of a computing environment that has been associated with a security incident. The attack path context comprises contextual objects associated with quantifying an impact of the security incident. Contextual objects can include time and location, affected assets, attack vector, attack tactic and techniques, regulatory and compliance obligation, and sensitivity of resources.

The contextual attack disruption engine uses correlations and investigations—associated with context and security impact of an identified security incident in a computing environment—to support identifying an attack disruption plan including measures and strategies to interrupt, mitigate, or thwart cyberattacks. The identified security incident can be a multi-stage attack that is consists of multiple interconnected stages or components. In this way, the identified security incident can be associated with a plurality of attack paths—each attack path associated with an attack path context and security impact.

An attack refers to a sequence of steps, or stages that an attack follows to achieve their objectives in a target computing environment. For example, identifies a series of vulnerabilities, misconfigurations, or weaknesses exploited by the attacker to undertake their attack (e.g., gaining unauthorized access, stealing sensitive data, or disrupting operations). An attack path can be a known attack path that refers to a known sequence of steps or action that an attack follows to compromise a computing environment. A predicted attack path is a hypothetical sequence of steps or stages that an attacker is anticipated to follow to achieve their objectives in a target computing environment. A predicted attack can be based on model techniques associated with known attack paths.

Security impact refers to consequences or effects (e.g., a quantified security incident cost) of a security incident to a computing environment. Security impact can be based on, contextual objects and determining costs associate with contextual objects. For example, data sensitivity, data loss, and operational disruption. An attack path context can support generating a security incident impact analysis that includes a predicted quantified security incident cost. The predicted quantified security incident cost of one or more attack disruption plans to select a designated attack disruption plan for the security incident.

At a high level, a security management system can be implemented for a computing environment to secure the computing environment again cyberattacks. The security management system can implement a contextual attack disruption engine to monitor the computing environment. The computing environment can be associated with a plurality of computing resources (e.g., multiple tenants) that are monitored. Monitoring the computing environment may identify a security incident. The security incident can specifically be a validated attack that has been successfully executed in part and confirmed to have breached or compromised the computing environment. The validated attack can be an ongoing attack or multi-stage attack that can be associated with additional attacks steps beyond the attack steps that have already been performed.

A predictive model can be generated and updated for generating attack disruption plans. The predictive model (e.g., a security incident predictive model) can be an algorithm that is designed to evaluate context and impact for predicted attack paths of a security incident to support generating attack disruption plans. The predictive model may operate based in part of previous steps associated with the security incident to make predictions of predicted attack paths associated with the security incident. In one example, the predictive model can model a map and path of a sequence of alerts that are involved in a security incident. The predictive model can generate output (e.g., security incident predictive model analysis) that is data associated with the predictive model that can be analyzed, updated, and provided for display.

The contextual attack disruption engine can calculate the cost of steps in an attack path and an attack path context of the attack path. The attack path context can refer to contextual objects including specific circumstances, conditions, computational factors, and resources surrounding the plurality of predicted attack path associated with the security incident. Attack paths can include vulnerability and weakness, access controls and permission, sensitivity of data, security defenses and countermeasures, etc.

Costs can be generated for a predicted attack path based on the attack path context of the corresponding predicted attack path. Costs can be associated with contextual objects of the predicted attack path. Costs can include actual quantified security incident costs and predicted quantified security incident costs. In one example, the cost can be positive costs and negative costs. The positive costs can be associated with a step or sequence of the path that has been compromised, and negative costs can be associated with a step or sequence that can be disrupted. Each resource identified in the attack path context for the attack path can be associated with a cost. In this way, the cost can be referred to as security incident impact analysis.

The security incident impact analysis can specifically include a ranked value for each resource (e.g., contextual objects) associated with the plurality predicted attack paths. The contextual attack path disruption engine employs the security incident impact analysis to update the predictive model. The cost is added to the predictive model that includes the plurality of predicted attack paths, and resources. The ranked values are employed to determine an attack disruption plan that minimizes expected loss of value. A designated attack disruption plan (e.g., an optimal attack disrupted plan)—that most minimizes an expected loss value—is selected.

By way of illustration, the contextual attack disruption engine supports selecting an attack disruption plans that would minimize loss to sensitive assets over non-sensitive assets. Impact of an attack can be inferred based on a predictive model (e.g., a map and path of sequence of alerts that are involved in a security incident). The predictive model can map whether a potential sensitive asset could be accessed. If so, the attack disruption plan can include a strong disruption approach such as disabling the user, instead of a weak disruption approach which will block some of the user's actions if the case does not involve sensitive assets.

In another example, a business impact can be evaluated prior to deploying an attack disruption plan. Based on the attack path context, the security incident may involve potential impact on critical assets and high confidence based on the attacker's skill level, and a different attack disruption plan may employed in contrast to a security incident that did not involve impact on critical assets and further include low level of confidence of the attacker's skill level. The context gives visibility to a potential kill-chain of the attack and the attacker's progress across the attack. The more advanced the attacker, the more confidence that exists to apply strong disruption approaches. In earlier stages of an attack, weaker disruptions may be employed.

Advantageously, the embodiments of the present technical solution include several inventive features (e.g., operations, systems, engines, and components) associated with a security management system having a contextual attack disruption engine. The contextual attack disruption engine supports generating security incident predictive model analysis, attack path contexts, security incident impact analysis that support performing contextual attack disruption in a security management system. The contextual attack disruption resources (e.g., operations, interfaces, and data) are a solution to a specific problem (e.g., limitations in providing comprehensive context-based attack disruption with consideration of both contextual factors influencing a security incident and the broader impact to a computing environment). The security incident predictive model and security incident impact model provides models for considering security incident predictive model analysis and security incident impact analysis in attack disruption planning. Moreover, contextual attack disruption data is generated and made accessible via a security management client.

### Example Systems and Resources

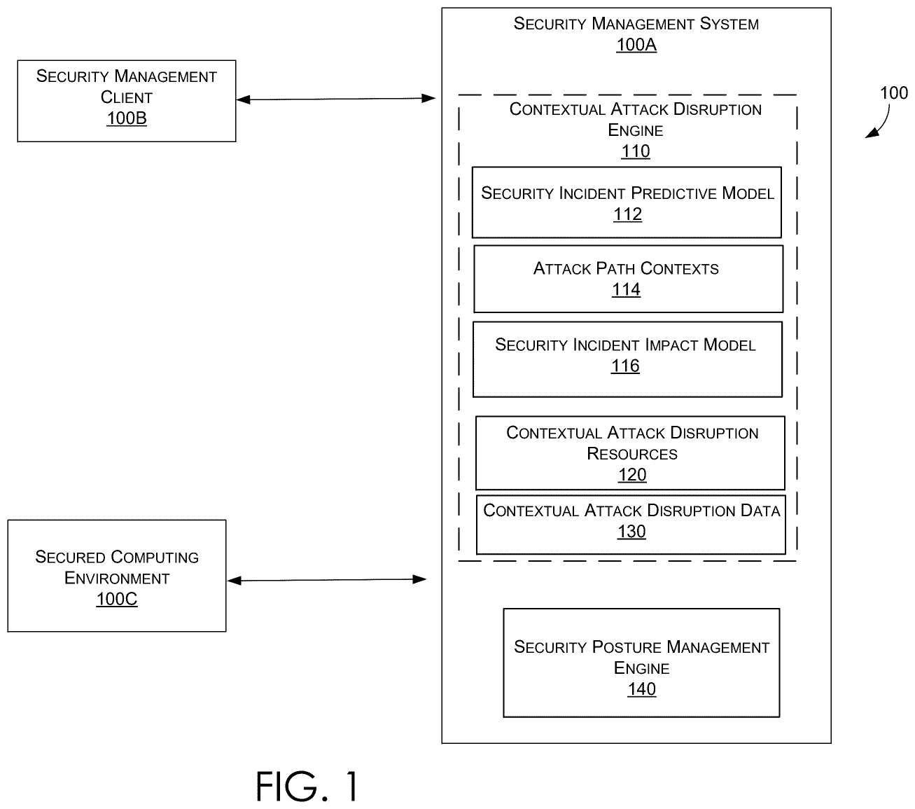

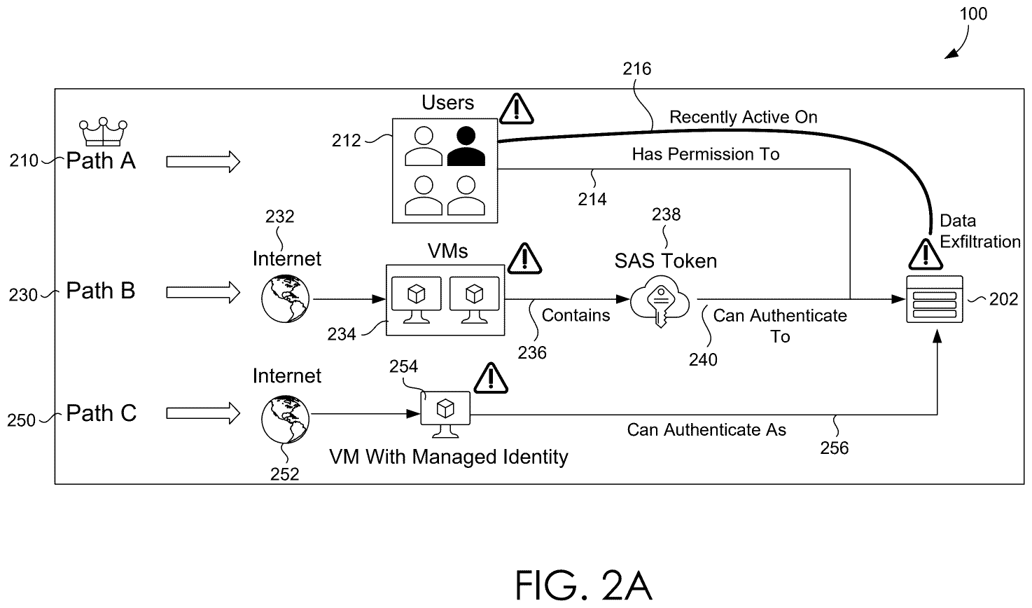

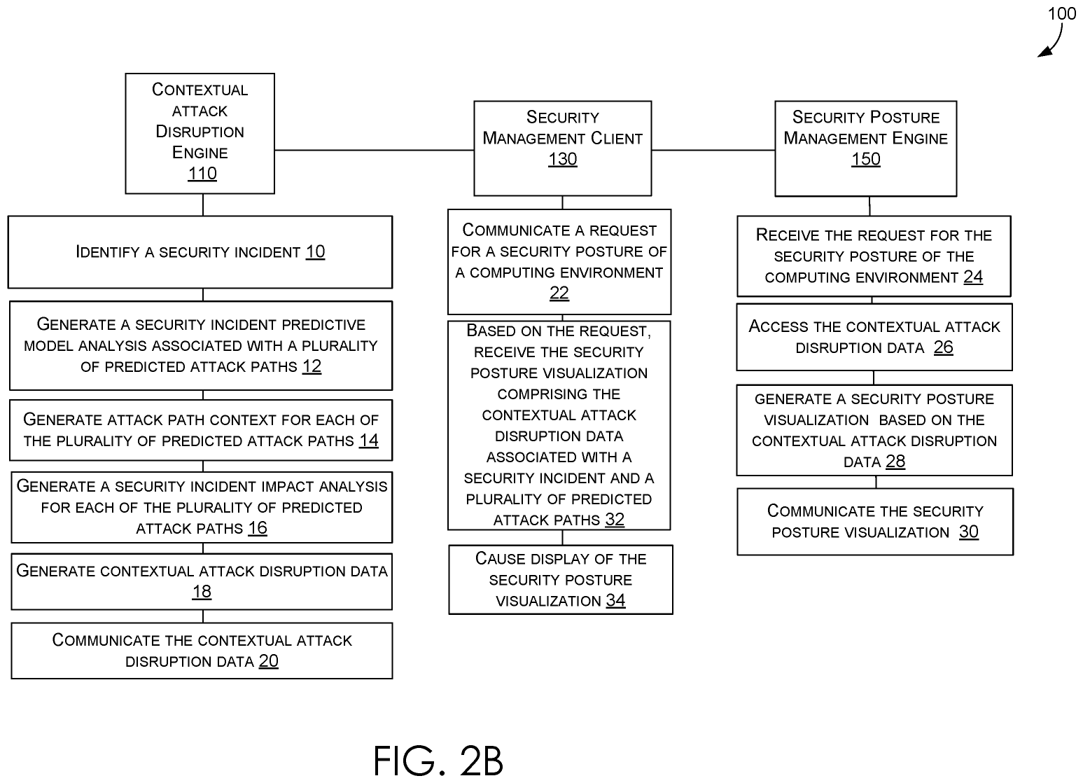

Aspects of the technical solution can be described by way of examples and with reference to FIGS. 1, 2A and 2B. FIG. 1 illustrates a cloud computing environment (system) 100, security management system 100A, security management client 100B; secured computing environment 100C; contextual attack disruption engine 110, security incident predictive model 112, attack path contexts 114, security incident impact model 116; contextual attack disruption resources 120; contextual attack disruption data 130; and security posture management engine 140.

The security management system 110A is associated with a security management client 100B, a secured computing environment 100C, and contextual attack disruption engine 110 for providing contextual attack disruption functionality. In particular, the context attack disruption engine 110 operates to generate attack disruption plans (e.g., candidate attack disruption plans). An attack disruption plan is a context-impact-based incident response configuration for responding to an identified security incident.

A plurality of predicted attack paths of a real time security incident can be identified, such that corresponding attack path contexts (e.g., attack path contexts 114) are determined. The attack path contexts 114 can be used to evaluate resources (e.g., contextual objects) that can be impacted by a security incident to help select an optimal disruption plan. In this way, a security incident that involves storage accounts with sensitive information will be more prioritized for investigation than storage accounts without sensitive information.

The contextual disruption engine 110 employs a security incident predictive model 112 to generate a security incident predictive model analysis. The security incident predictive model 112 is an algorithm that is designed to evaluate context and impact for predicted attack paths of a security incident to support generating attack disruption plans. The security incident predictive model can specifically model next steps of a multi-stage security incident. The security incident predictive model 112 analysis can refer to output generated from analyzing input data using the security incident predictive model 112. The security incident predictive model analysis includes one or more predicted attack paths. Security incident predictive model analysis can further include attack disruptions plans, risk scoring, and prioritization associated with a security incident.

The contextual disruption engine 110 generates attack path contexts 114 for predicted attack paths. An attack path can refer to a sequence of steps or action that an attack follows to compromise a computing environment. The attack path contexts 114 include contextual objects associated with quantifying an impact of the security incident. Contextual objects can include time and location, affected assets, attack vector, attack tactic and techniques, regulatory and compliance obligation, and sensitivity of resources.

The contextual disruption engine 110 employs a security incident impact analysis model 116 to generate a security incident impact analysis. The security incident impact model 116 is an algorithm that is designed to determine a security incident cost of a contextual object relative to a security incident. The security incident impact model analysis refers to security impact data including consequences or effect (e.g., a quantified security incident cost) of a security incident to a computing environment. The security incident impact model 116 uses an attack path context to generate the security incident impact analysis that includes an actual or predicted quantified security incident cost that is associated with an attack path. The security incident impact analysis can include positive costs and negative costs. The positive costs can be associated with a step or sequence of the path that has been compromised, and negative costs can be associated with a step or sequence that can be disrupted. Each resource identified in the attack path context for the attack path can be associated with a cost.

In one implementation, the security incident predictive model 112 for the next steps of attack path p based on previous steps can be computed using:

$$P ( p ) = P ( {x}_{n} , … , {x}_{t + 1} , {x}_{t} \vert {x}_{t - 1} , … , {x}_{1} )$$

P(p): the probability of an event p. The probability of observing a specific outcome or event P(xₙ, . . . , xₜ₊₁, xₜ|xₜ₋₁, . . . , x₁) represents the conditional probability of observing the sequence of events xₜ through xₙ given the previous events x₁ through xₜ₋₁ₙ. In other words, it provides probability of a future event occurring, conditioned on the knowledge of past events up to a certain point.

The security incident predictive model 112 can used to identify or generate attack disruption plans. An attack disruption plan d can be generated by adding positive weights k (representing the potential value loss due to resource compromise by attackers) and negative weights l (representing the potential value loss if the resource is turned off due to disruption).

$$E ( d ) = \sum P ( {x}_{n} \cdot ( {k}_{n} - {l}_{n} ) , … , {x}_{t + 1} \cdot ( {k}_{t + 1} - {l}_{t + 1} ) , {x}_{t} \cdot ( {k}_{t} - {l}_{t} ) \vert {x}_{t - 1} , … , {x}_{1} )$$

E(d) represents the expected value of d computed by summing over the conditional probabilities of certain sequences of events, given the knowledge of past events up to a certain point. In this way, the contextual disruption engine 110 generates attack disruption plans for a security incident based on an attack path, attack path context, and security incident impact analysis. Generating an attack disruption plan can be based on ranking contextual objects—that can be a potential step—as a candidate for disruption. Each attack disruption plan can associated with a plurality of contextual objects with a total expected loss value.

The contextual disruption engine 110 selects an attack disruption plan. The attack disruption plan can be selected from a plurality of candidate attack disruption plans with corresponding expected loss value. The attack disruption plan can be referred to as a designated attack disruption plan. The designated attack disruption plan is an optimal disruption plan that minimizes expected loss value. By way of illustration, the contextual disruption engine 110 may implement a scoring model for loss minimization scoring. The scoring model can be a framework used to assign scores to each identified contextual object or attack disruption plan based on various factors related to its severity, likelihood, and potential impact on the computing environment. Scoring can specifically be associated with individual attack paths. The scoring model provides a structured approach to quantifying risks and prioritizing mitigation efforts. The scoring model further specifies the methodology or algorithm used to calculate the overall score for each attack disruption plan. The scoring model defines the scale or range of scores used to assess risks. This could be a numerical scale, such as 1 to 10 or 1 to 100, or a qualitative scale, such as low, medium, or high risk.

It is contemplated that the security incident predictive model analysis, security incident predictive model analysis, attack path contexts, security incident impact analysis, attack disruption plan can be used to define contextual attack disruption data. The contextual disruption engine can communicate attack disruption data to be provided as part of security posture information for the secured computing environment 100C—via the security posture management engine 140.

The contextual disruption engine 110 can communicate the attack disruption plan. The attack disruption plan can be communicated to cause execution of the attack disruption plan on the computing environment. The contextual attack disruption engine can employ several technical mitigation strategies. These may involve actions such as revoking or altering authentication tokens, bolstering access control policies, and implementing restrictions on high-level system operations. Limiting the scope of a security incident can reduce cost and damage associated with blocked legitimate operations in a computing environment. The attack disruption plan can be part a comprehensive security strategy involves a range of actions aimed at safeguarding computing environments against cyber threats.

The attack disruption plan can specifically be based on stronger and weaker variations of the same remediation action. For example, network segmentation can be strengthened through micro-segmentation, enforcing granular access controls to minimize lateral movement and mitigate breaches, whereas basic VLAN segmentation may offer only limited protection. Access control enforcement can be bolstered with role-based access control (RBAC) and continuous monitoring to dynamically adjust access privileges based on user behavior and risk levels, whereas static access controls may lead to over-privileged accounts and inadequate alignment with business requirements. Endpoint security measures can be fortified with comprehensive endpoint security suites, incorporating behavior-based analysis and sandboxing to detect and mitigate advanced malware and zero-day threats, whereas relying solely on traditional antivirus software may leave endpoints vulnerable to targeted attacks.

By way of illustration, in the event of a live security incident, the decision-making process regarding the deployment of disruption measures can depend on differentiating between sensitive and non-sensitive assets within the organization's infrastructure. This differentiation informs the selection of appropriate disruption capabilities tailored to the specific risk posed by the incident. Sensitive assets encompass critical resources, such as databases containing personally identifiable information (PII), financial records, trade secrets, or intellectual property, which, if compromised, could result in significant damage to the organization's reputation, financial standing, or regulatory compliance. Non-sensitive assets, on the other hand, include resources that are less critical to the organization's operations and have a lower impact if compromised. These may include public-facing websites, non-critical applications, or development servers containing non-sensitive data.

During a live security incident, the analysis of the potential impact based on the sequence of alerts and the attacker's progression helps determine whether sensitive assets are at risk of being accessed or compromised. This analysis involves mapping the attack path and identifying the alerts associated with the incident to assess the likelihood of sensitive asset exposure. For example, consider a scenario where a security incident involves suspicious activity detected on a server hosting a database containing sensitive customer information. In this case, the contextual analysis would prioritize the protection of the sensitive asset, as unauthorized access to the database could lead to data breaches and regulatory violations.

In such situations, more “strong” disruption approaches, such as user account disablement or immediate network segmentation to isolate the compromised server, may be warranted. These measures are designed to swiftly mitigate the risk of sensitive asset exposure and prevent further unauthorized access by the attacker. Conversely, if the incident does not involve sensitive assets or if the potential impact is deemed low, a less severe disruption approach may be appropriate. For instance, blocking specific user actions or restricting access to non-critical resources may suffice to contain the incident without overly disrupting normal business operations. By tailoring disruption capabilities based on the sensitivity of the assets involved in the incident, organizations can effectively prioritize their response efforts, mitigate the risk of data breaches or unauthorized access, and minimize the impact on critical business operations. This approach ensures that disruption measures are aligned with the severity of the incident and the importance of protecting sensitive assets from compromise.

In another scenario, a security incident is detected involving suspicious activity on a financial server hosting transactional data. In this scenario, the contextual analysis would assess the significance of the financial server and the potential ramifications of a breach or compromise. For example, if unauthorized access to the financial server could lead to the theft of sensitive financial data or disruption of financial transactions, the impact on critical assets would be deemed high. The confidence level associated with deploying disruption measures is directly influenced by the contextual assessment of the security incident's impact on critical assets. If the incident poses a significant threat to critical assets, such as the financial server in our example, the confidence level for deploying disruption measures would be higher. Conversely, if the incident involves non-critical assets or has minimal impact on essential operations, the confidence level may be lower.

Moreover, the contextual analysis provides insights into the attacker's progression across the attack lifecycle and the potential kill chain of the attack. Advanced attackers often follow a multi-stage approach, progressing from initial reconnaissance and exploitation to lateral movement and data exfiltration. By analyzing the attacker's tactics, techniques, and procedures (TTPs), security teams can anticipate the attacker's next moves and adjust their response accordingly. For instance, in the early stages of an attack, where the attacker's objectives and capabilities are still unclear, security teams may opt for “weaker” disruption measures to avoid causing unintended consequences. These measures could include temporary network segmentation, user account lockdowns, or enhanced monitoring and logging. As the attack progresses and the attacker's intentions become clearer, security teams may escalate to “stronger” disruption measures, such as deploying intrusion prevention systems (IPS), blocking known malicious IP addresses, or isolating compromised systems from the network. In this way, the contextual analysis of a security incident provides critical insights into the potential impact on critical assets, the attacker's progression across the attack lifecycle, and the appropriate level of response. By aligning disruption measures with the evolving threat landscape and the significance of critical assets, organizations can effectively mitigate the risk of cyber-attacks and protect their most valuable resources.

With reference to FIG. 2A, FIG. 2A illustrates cloud computing environment 100 including data exfiltration 202, path A 210, path B 230, and path C 250; internet-enabled access 232, internet-enabled access 252; users 212, has permission to 214, recently active on 216, virtual machines (VMs) 234, contains 236, SAS token 238, can authenticate to 240, VM with managed identity 254, can authenticate to 256.

The cloud computing environment 100 includes a plurality of contextual objects. Contextual objects can be predefined elements and attributes that provide contextual information for a security incident predictive model and a security incident impact model. In particular, the security incident impact model employs the contextual objects to generate quantified security incident cost that is further employed by the security incident predictive model to identify attack disruption plans. The value of context in distinguishing between different attack paths and identifying potential security incidents becomes evident through the analysis contextual objects.

Consider the three distinct attack paths: Path A 210 involves users 212 with authorized permissions 214 accessing a data exfiltration component 202, Path B involves internet-enabled access 232 to VMs 234 housing SAS tokens 238 for authentication to the data exfiltration component 202, and Path C involves internet-enabled access 252 to a VM 254 equipped with a managed identity for authentication to the data exfiltration component 202. The data exfiltration component 202 has been compromised and under investigation.

For these potential attack vectors, the significance of context, particularly in the form of user activity logs is important. By investigating these logs, the security management system may uncover specific user interactions within Path A 210, where a user recently engaged with the data exfiltration component 202. This discovery serves as a pivotal indicator suggesting that Path A 210 may have been exploited by an attacker. The absence of such contextual insights could obscure crucial connections between user activity and the chosen attack path. Without granular visibility into user actions, security teams risk overlooking critical evidence that could shed light on the attacker's actions and aid in swift incident response.

Through rigorous analysis of contextual objects, including user activity logs and access control records, organizations can fortify their defense mechanisms against data exfiltration attempts and other malicious activities. This proactive approach enables the security management system to detect, mitigate, and neutralize security threats more effectively, thereby bolstering the resilience of the organization's cybersecurity posture.

With reference to FIG. 2B, FIG. 2B illustrates a cloud computing system 100 having contextual attack disruption engine 110, security management client 130, and security posture management engine 150.

At block, the contextual attack disruption engine 100, at block 10, identifies a security incident; at block 12, generates a security incident predictive model analysis associated with a plurality of predicted attack paths; at block 14, generates attack path context for each of the plurality of predicted attack paths; at block 16, generate security incident impact analysis for each of the plurality of predicted attack paths; at block 18, generates contextual attack disruption data; and at block 20, communicates the contextual attack disruption data.

The security management engine 130, at block 22, communicates a request for a security posture of a computing environment. The security posture management engine 150, at block 24, receives the request for the security posture of the computing environment; at block 26, access the contextual attack disruption data; at block 28, generates a security posture visualization based on the contextual attack disruption data; at block 30, communicates the security posture visualization. The security management engine 130, at block 32, based on the request, receives the security posture visualization comprising the contextual attack disruption data associated with a security incident and a plurality of predicted attack paths; and at block 34, causes display of the security posture visualization.

### Example Methods

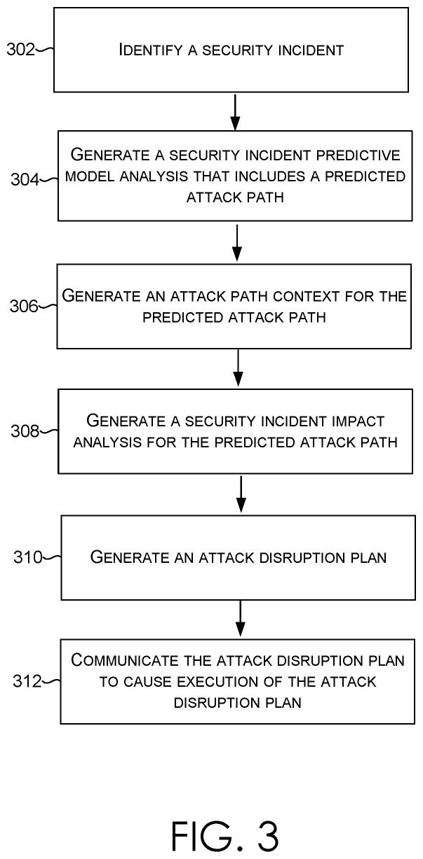

With reference to FIGS. 3, 4, and 5, flow diagrams are provided illustrating methods for providing context-based attack disruption using a contextual attack disruption engine of a security management system. The methods may be performed using the security management system described herein. In embodiments, one or more computer-storage media having computer-executable or computer-useable instructions embodied thereon that, when executed, by one or more processors can cause the one or more processors to perform the methods (e.g., computer-implemented method) in the security management system (e.g., a computerized system).

Turning to FIG. 3, a flow diagram is provided that illustrates a method 300 for providing context-based attack disruption using a contextual attack disruption engine of a security management system. At block 302, identify a security incident. At block 304, generate a security incident predictive model analysis that includes a predicted attack path. At block 306, generate an attack path context for the predicted attack path. At block 306, generate a security incident impact analysis for the predicted attack path. At block 310, generate an attack disruption plan. At block 312, communicate the attack disruption plan to cause execution of the attack disruption plan.

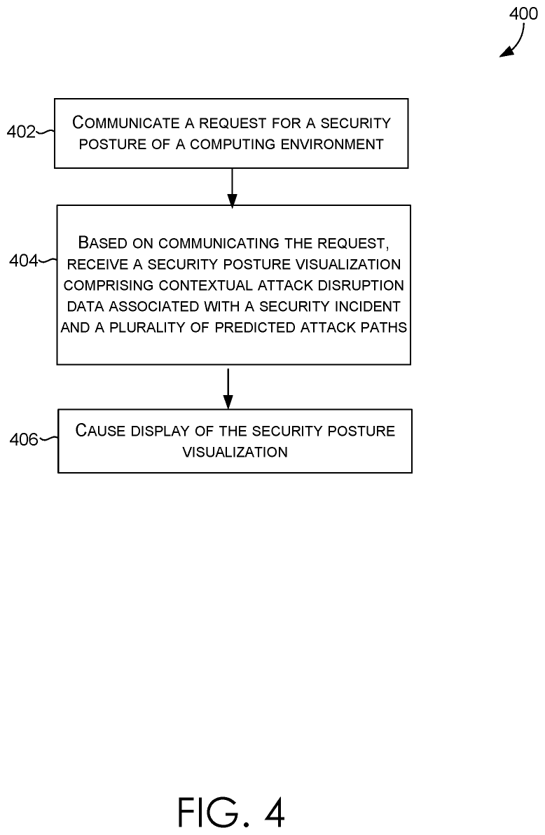

Turning to FIG. 4, a flow diagram is provided that illustrates a method 400 for providing context-based attack disruption using a contextual attack disruption engine of a security management system. At block 402, communicate a request for a security posture of a computing environment. At block 404, based on the request, receive a security posture visualization comprising contextual attack disruption data associated with a security incident and a plurality of predicted attack paths. At block 406, cause display of the security posture visualization.

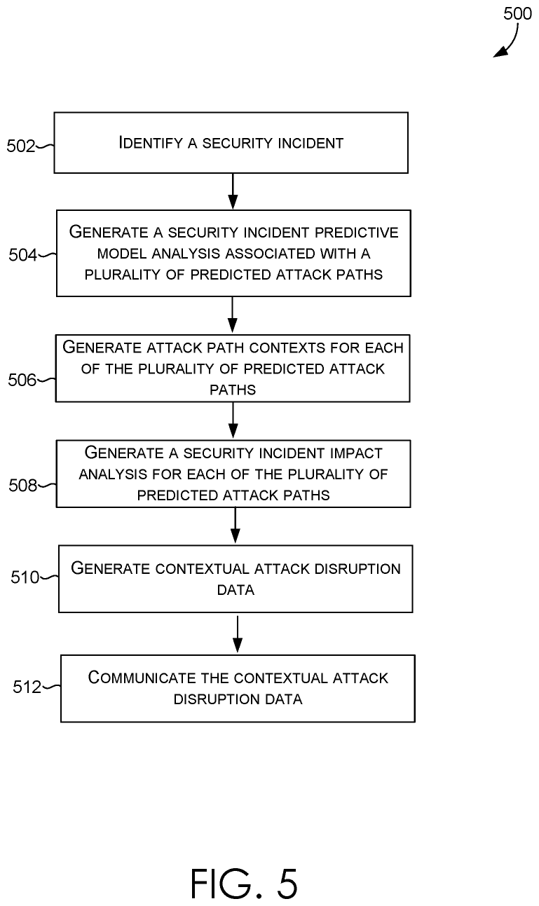

Turning to FIG. 5, a flow diagram is provided that illustrates a method 500 for providing context-based attack disruption using a contextual attack disruption engine of a security management system. At block 502, identify a security incident. At block 504, generate a security incident predictive model analysis associated with a plurality of attack paths. At block 506, generate attack path contexts for each of the plurality of predicated attack paths. At block 508, generate a security incident impact analysis for each of the plurality of predicted attack paths. At block 510, generate contextual attack disruption data. At block 512, communicate the contextual attack disruption data.

### Technical Improvement

Embodiments of the present techniques have been described with reference to several inventive features (e.g., operations, systems, engines, and components) associated with a security management system. Inventive features described include: operations, interfaces, data structures, and arrangements of computing resources associated with providing the functionality described herein relative with reference to a contextual attack disruption engine. Functionality of the embodiments of the present invention have further been described, by way of an implementation and anecdotal examples—to demonstrate that the operations for providing the contextual attack disruption engine as a solution to a specific problem in security management technology to improve computing operations in security management systems.

By way of example, the contextual attack disruption engine supports generating security incident predictive model analysis, attack path contexts, security incident impact analysis that support performing contextual attack disruption in a security management system. The contextual attack disruption resources (e.g., operations, interfaces, and data) are a solution to a specific problem (e.g., limitations in providing comprehensive context-based attack disruption with consideration of both contextual factors influencing a security incident and the broader impact to a computing environment). The security incident predictive model and security incident impact model provides models for considering security incident predictive model analysis and security incident impact analysis in attack disruption planning. Moreover, contextual attack disruption data is generated and made accessible via a security management client.

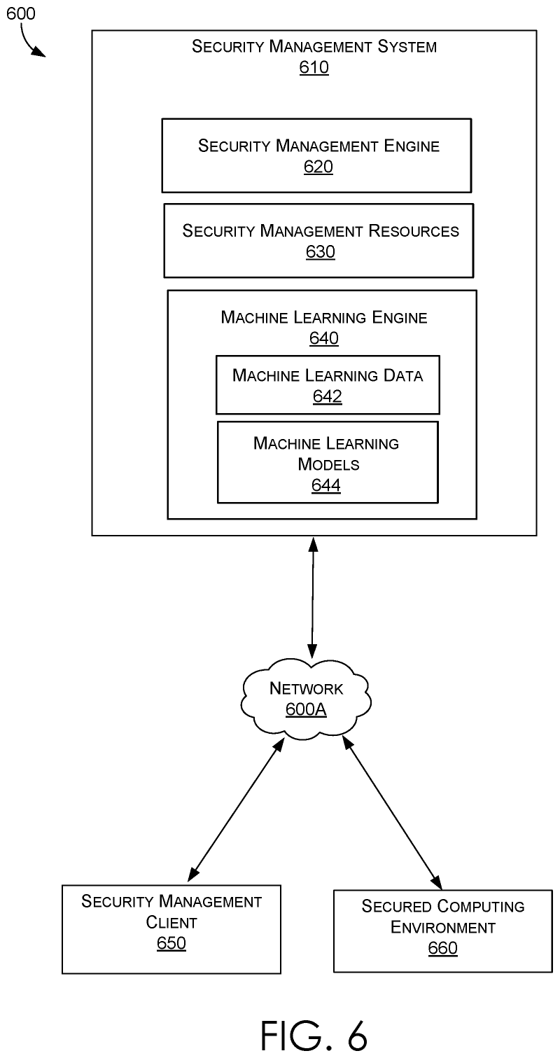

Aspects of the technical solution have been described by way of examples and with reference to FIGS. 1, 2A and 2B. FIG. 1 is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1 illustrates a high level architecture of the cloud computing system 100 in accordance with implementations of the present disclosure, among other engines, managers, generators, selectors, or components not shown (collectively referred to herein as “components”).

### Additional Support for Detailed Description

### Example Security Management System in a Computing Environment

Referring now to FIG. 6, FIG. 6 illustrates a computing environment in which implementations of the present disclosure may be employed. In particular, FIG. 6 shows a high level architecture of an example cloud computing platform 600 and security management system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing environment 100 provides computing system resources for different types of managed computing environments. For example, the cloud computing platform supports delivery of computing services—including compute, servers, storage, databases, networking, and intelligence. The components of cloud computing environment 600 may communicate with each other over a network 600A which may include, without limitation, one or more local area networks (LANs) and/or wide area networks (WANs).

The security management system 610 provides security management functionality for computing environments. The security management system 610 supports planning, implementing, controlling, and monitoring security measures to protect assets, resources, and information from various threats and risks in computing environment. Security management system 610 is configured to trigger alerts for potential or actual threats—including suspicious behavior or malicious behavior—in a computing environment. For example, an alert configuration can be defined to include alert settings, which if met, trigger an alert. The security alert can refer to a human-readable, technical notification regarding current vulnerabilities, exploits, and other security issues associated with a computing environment. The alert can be communicated to a client device that is managed by a security administrator who can then follow up on the alert.

Different types of potential threats and actual threats exist, for example, use of proxies to gain access to a computing environment or unauthorized running of crypto mining software in a computing environment. An attack on a cloud computing environment—for example, performed by a malicious actor—can include several attack operations that are executed to gain access to resources on the cloud computing environment. The attack operations can trigger alerts, when the security system is configured to monitor for these types of attack operations. If multiple attack operations are identified—and a determination that the attack operations are related is made—the alerts associated with the attack operations can be defined as a security incident. The security incident can refer to a collection of correlated alerts and corresponding security data that make up a story of an attack. The attack story can be associated with a security graph and an attack path definition that identifies attack objects (e.g., attack operations, compromised resources, file locations and file types). The attack path can describe how an attacker gained access to a computing environment and related operations and computing resources associated with the attack and unauthorized access. A security incident can advantageously combine multiple alerts associated with a single attack to support managing and responding to the security incident.

The security management system 610 includes a security management engine 620 that is a computing environment that supports executing computational tasks associated with the security management system 610. The security management engine 620 can be a hardware or software component that performs computational operations, such as, mathematical calculations, data processing, and algorithm execution. The security management system 610 integrates security management resources 630 into security management system 610 to effectively provide security management in a computing environment.

The security management engine 610 can be a security posture management engine that is responsible for communicating with security management engine client 660. The security management engine client 660 supports client-side security management operations for providing security management in the security management system 610. The security management engine client 660 supports presenting a security posture visualization associated with security management engine output and communicating an indication to perform a remediation action associated with security management engine output. The security management engine 620 operates to provide visibility to security status of resources in a computing environment. Security posture information can be associated with security management engine output. Security posture information can include security management engine output as described herein with regard to the technical solution.

The security management engine 620 includes a security graph API that provides access to a security graph security graph data. The security graph provides telemetry data associated with a plurality of resources in a computing environment. In particular, the telemetry data can be security data that is associated with security providers in a computing environment. The security graph and security graph API can support integrating security alerts from different security providers via an API connector that streams alerts to the security management engine 620.

The security management engine 620 may assess threats and develop risk scores—using risk assessment operations. A risk associated with security management engine output can used to generate security posture information. In particular, a risk score can refer to a numerical value that represents the level of risk associated with a particular security incident associated with the annotation. It takes into account various factors such as the likelihood of the event occurring and the potential impact of the event if it does occur. The risk score is used to prioritize actions and allocate resources accordingly.

The security management engine 620 can further support generating security posture visualizations based on security management engine output. The security posture information can be generated security management engine output such that security posture information is prioritized and filtered. A prioritization identifier (e.g., high, medium, low) can be provided in the security posture visualization in combination with an alert associated with a security incident. Alternatively, a notification associated with the security management information, security prioritization information or the alert can be communicated. Other variations and combinations of communications associated with security management engine output are contemplated with embodiments described herein.

The security management client 650 can support accessing a security posture visualization and causing display of the security posture visualization. The security management client 650 can include the security posture management engine client that supports receiving security posture information associated security management engine output from the security management system 610 and causing presentation of the security posture information. The security posture information can specifically include security posture visualizations associated with the security management engine output. The secure posture visualization can further include remediation actions associated different alerts—including alerts that are associated with the security management engine output. The security management system can be a security management system described in U.S. patent application Ser. No. 18/451,405, filed Aug. 17, 2023, entitled “ARTIFICIAL INTELLIGENCE ENGINE IN A SECURITY MANAGEMENT SYSTEM,” which is incorporated herein by reference in its entirety.

The security management client 130 can further support executing a remediation action. In particular, the security posture visualization can include a remediation action for an alert associated with security management engine output. The security management client 130 can receive an indication to perform the remediation action associated with security management engine output. Based on receiving the indication to execute the remediation action, the security management client 130 can communicate the indication to execute the remediation action to cause execution of the remediation action.

The security management resources 630 refer to computing elements (e.g., components, capability, or entities) that collectively enable the security management engine 620 operations. The security management resources 630 encompass a spectrum of computing elements, beginning with the diverse operations the security management resources 630 can perform, ranging from complex computations to data manipulations. Interfaces, an integral part of the security management resources 630, provide the means for both user interaction and seamless integration with external systems, ensuring a dynamic and interactive computing experience. The data facet of the security management resources 630 involves various types: input data, which is the information provided for processing; processing data, representing the data manipulated during computational tasks; and output data, the results generated by the security management engine 620. In this way, the security management resources 630 support the broader security management engine 620 and security management system 610.

Security management resources 630 contextual attack disruption resources that support leveraging contextual information and impact analysis to thwart or mitigate ongoing attacks on a computing environment. Contextual attack disruption resources encompass the core operations, interfaces, and data components within security management system 610, collectively supporting its functionality in overseeing diverse computing environments across the cloud computing system 600. Operations of the contextual attack disruption resources include understanding the normal behavior and processes within the computing environment. This includes monitoring system operations, network traffic, user activities, and application behavior to establish a baseline of normalcy. When an attack occurs, security analysts can analyze the deviation from normal operations to identify anomalies or suspicious activities. By understanding the context in which these deviations occur, such as the timing, sequence, and frequency of events, analysts can assess the severity and potential impact of the attack. Interfaces, including graphical user interfaces, command-line interfaces, web-based portals, APIs, and integration points, facilitate interaction with administrators, end-users, devices, and other cloud computing systems. Data components encompass the storage, processing, and transmission of data within the computing environment. This includes databases, file systems, memory, and data pipelines. Contextual attack disruption in the context of data components involves monitoring data flows, access patterns, and data integrity to detect and mitigate attacks targeting sensitive information.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 140 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The security management client 650 supports access to security management system 660. Security management client 650 provides a graphical or command-line interface for users or administrators to interact with security management system 610, handling tasks such as planning, implementing, controlling, and monitoring security measures to protect assets, resources, and information from various threats and risks in computing environments. The security management client 650 supports centralized security management, security enforcement, and compliance within a computing environment (e.g., organization's infrastructure), empowering efficient security administration and safeguarding resources.

Secured computing environment 660 can refer to a computing environment that is secured using the security management system 610. For example, cloud computing environments provided by cloud providers encompass various types, including public, private, hybrid, and multi-cloud environments, as well as containerized environments. In a public cloud setup, resources are shared among multiple customers and accessed over the internet, with security managed by the provider through measures like network segmentation and encryption. Private clouds, dedicated to a single organization, offer greater control and are secured through strict access controls and encryption, either by the organization itself or a third-party provider. Hybrid clouds combine elements of public and private clouds, requiring integrated security measures across both environments, such as identity federation and consistent monitoring. Multi-cloud environments leverage services from multiple providers, necessitating standardized security policies and controls for consistent protection. Containerized environments, utilizing technologies like Docker and Kubernetes, secure applications through container image scanning, runtime monitoring, and access control. Across all types, the security management system 610 can provide security management, including compliance certifications, threat intelligence, and security consulting, to safeguard data, infrastructure, and applications from evolving cyber threats and ensure adherence to regulatory requirements.

### Example Distributed Computing System Environment

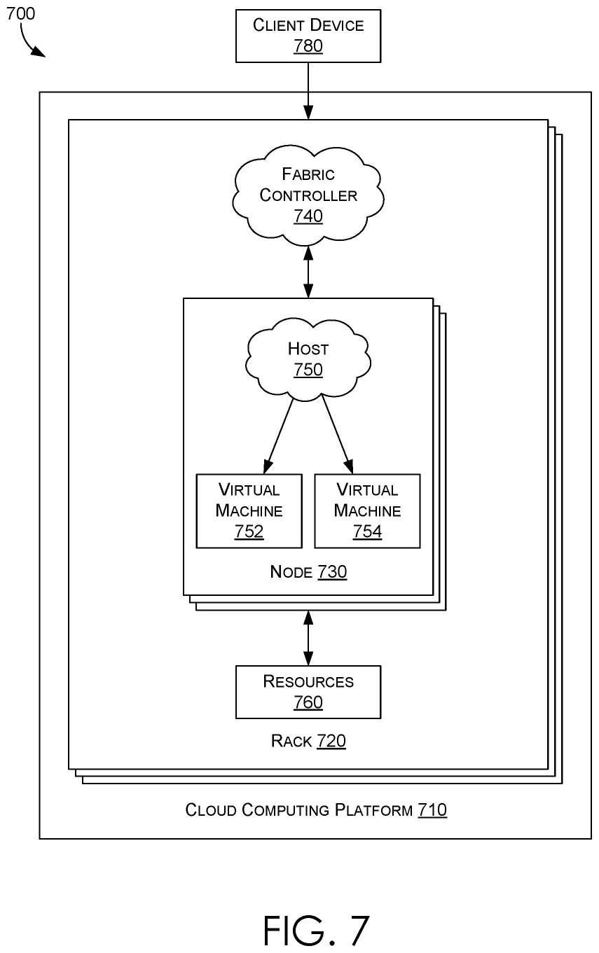

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

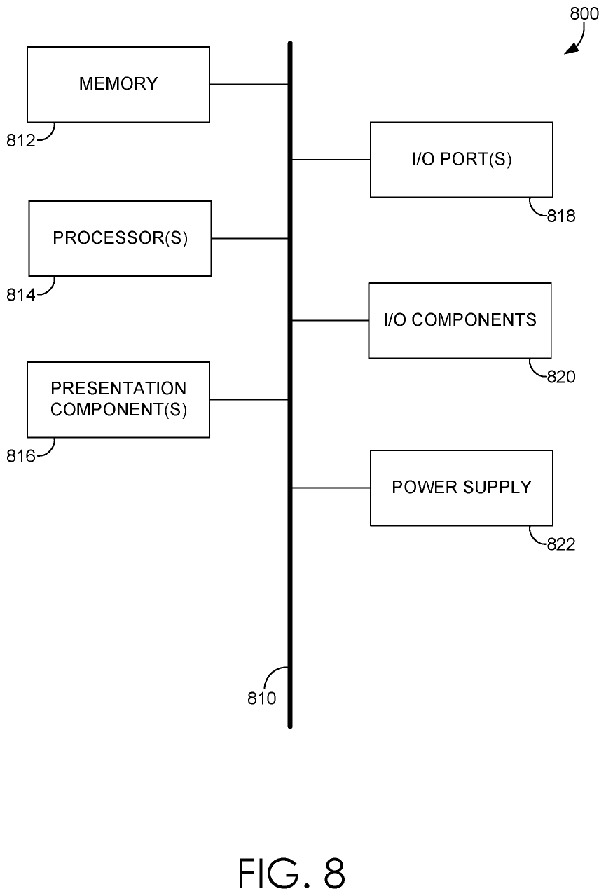

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
identifying a security incident;
generating a security incident predictive model analysis that includes a predicted attack path;
generating an attack path context for the predicted attack path, wherein the attack path context comprises a contextual object associated with quantifying a security incident cost;
generating a security incident impact analysis for the predicted attack path;
generating an attack disruption plan; and
communicating the attack disruption plan.

2. The system of claim 1, wherein the security incident is a multi-stage security incident associated with a first step in an attack path sequence and one or more additional steps in the attack path sequence, wherein the first step has been executed; and
wherein the predicted attack path is identified based on the first step, the predicted attack path is a hypothetical sequence of steps that an attack follows to compromise a computing environment.

3. The system of claim 1, wherein generating the security incident predictive model analysis is based on a security incident predictive model, the security incident predictive model comprises a plurality of predicted attack paths, the plurality of predicted attack paths are associated with corresponding attack path contexts and security incident impact analysis.

4. The system of claim 1, wherein the security incident impact analysis comprises a predicted quantified security incident cost associated with a plurality of contextual objects associated the predicted attack path.

5. The system of claim 1, wherein generating the security impact analysis is based on determining positive costs and negative costs associated with contextual objects of the predicted attack path.

6. The system of claim 1, wherein generating the attack disruption plan is based on the predicted attack plan, the attack path context, and the security incident impact analysis.

7. The system of claim 1, wherein generating the attack disruption plan comprises generating a plurality attack disruption plans as candidate attack disruption plan, wherein the attack disruption plan is a designated attack disrupted plan selected based on a total expected loss value.

8. The system of claim 1, wherein a security posture management engine supports generating a security posture visualization comprising contextual attack disruption data associated with the security incident and a plurality of predicted attack paths.

9. The system of claim 1, the operations further comprising:
communicating, from a security management client, a request for a security posture of a computing environment;
based on communicating the request, receiving a security posture visualization comprising contextual attack disruption data associated with the security incident and a plurality of predicted attack paths; and
causing display of the security posture visualization.

10. The system of claim 1, the operations further comprising:
receiving an indication to execute a remediation action associated with the contextual attack disruption data; and
communicating the indication to execute the remediation action to cause execution of the remediation action.

11. A computer-implemented method, the method comprising:
identifying a security incident;
generating a security incident predictive model analysis that includes a predicted attack path;
generating an attack path context for the predicted attack path, wherein the attack path context comprises contextual objects associated with quantifying a security incident cost;
generating a security incident impact analysis for the predicted attack path;
generating contextual attack disruption data; and
communicating the contextual attack disruption data.

12. The method of claim 11, wherein generating the security incident predictive model analysis is based on a security incident predictive model, the security incident predictive model comprises a plurality of predicted attack paths, the plurality of predicted attack paths are associated with corresponding attack path contexts and security incident impact analysis.

13. The method of claim 11, wherein the security incident impact analysis comprises a predicted quantified security incident cost associated with a plurality of contextual objects associated the predicted attack path.

14. The method of claim 11, wherein generating the security impact analysis is based on determining positive costs and negative costs associated with contextual objects of the predicted attack path.

15. The method of claim 11, wherein generating the attack disruption plan is based on the predicted attack plan, the attack path context, and the security incident impact analysis.

16. The method of claim 11, the method further comprising:
generating a security posture visualization comprising contextual attack disruption data associated with the security incident and a plurality of predicted attack paths.

17. One or more computer-storage media having computer-executable instructions embodied thereon that, when executed by a computing system having a processor and memory, cause the processor to perform operations, the operations comprising:
communicating a request for a security posture of a computing environment;
based on communicating the request, receiving a security posture visualization comprising contextual attack disruption data associated with the security incident and a plurality of predicted attack paths; and
causing display of the security posture visualization.

18. The media of claim 17, the operations further comprising:
identifying a security incident;
generating a security incident predictive model analysis that includes a predicted attack path;
generating an attack path context for the predicted attack path, wherein the attack path context comprises a contextual object associated with quantifying a security incident cost;
generating a security incident impact analysis for the predicted attack path;
generating an attack disruption plan; and
communicating the attack disruption plan.

19. The media of claim 18, wherein generating the security incident predictive model analysis is based on a security incident predictive model, the security incident predictive model comprises a plurality of predicted attack paths, the plurality of predicted attack paths are associated with corresponding attack path contexts and security incident impact analysis.

20. The media of claim 18, wherein a security posture management engine supports generating a security posture visualization comprising contextual attack disruption data associated with the security incident and the plurality of predicted attack paths.
